(19) United States
(12) Patent Application Publication
(10) Pub. No.: US 2012/0047296 A1
(43) Pub. Date: Feb. 23, 2012

(54) CONTROL MODULE FOR COMMUNICAION NETWORKS AND METHOD FOR USING THE SAME

(75) Inventors: JO-YU CHANG, Tu-Cheng (TW); ETHAN CHANG, Tu-Cheng (TW)

(73) Assignee: HON HAI PRECISION INDUSTRY CO., LTD., Tu-Cheng (TW)

(21) Appl. No.: 12/886,669

(22) Filed: Sep. 21, 2010

(30) Foreign Application Priority Data
Aug. 23, 2010 (TW) 99128122

(51) Int. Cl. G06F 3/00; G06F 13/00

(52) U.S. Cl. 710/51; 710/110

(57) ABSTRACT

A control module for controlling a communication network includes a master control unit generating a master control signal and a master pulse signal, a slave control unit generating a slave control signal; and a switch unit electrically connected to the master control unit, the slave control unit, and the communication network. The switch unit includes a timer and a multiplexer. The timer receives the master pulse signal, generates a first selecting signal when the master pulse signal exists, or generates a second selecting signal when the master pulse signal stops. The multiplexer receives the master control signal, the slave control signal, and the first/second selecting signal, transmits the master control signal to the communication network when receiving the first selecting signal, or transmits the slave control signal to the communication network when receiving the second selecting signal.

### BACKGROUND

1. Technical Field

The present disclosure relates to control modules for communication networks, and particularly to a control module capable of switching a communication network to be selectively controlled by different control units.

2. Description of Related Art

A server of a communication network (e.g., the Internet or intranets) generally includes a master control unit and at least one slave control unit. In use, the master control unit is first used to control the communication network. When the master control unit malfunctions, the communication network is switched to be controlled by the slave control unit, until the master control unit is repaired, then the communication network is switched to be controlled by the master control unit again. However, most conventional switch devices for switching communication networks to be selectively controlled by their master control units and slave control units have complicated hardware structures and are costly.

Therefore, there is room for improvement within the art.

### BRIEF DESCRIPTION OF THE DRAWINGS

Many aspects of the present control module can be better understood with reference to the following drawings. The components in the various drawings are not necessarily drawn to scale, the emphasis instead being placed upon clearly illustrating the principles of the present control module. Moreover, in the drawings, like reference numerals designate corresponding parts throughout the figures.

FIG. 1 is a block diagram of a control module for communication networks, according to a first exemplary embodiment.

FIG. 2 is a flow chart of a method for switching a communication network to be selectively controlled by different control units, according to an exemplary embodiment.

FIG. 3 is a block diagram of a control module for communication networks, according to a second exemplary embodiment.

### DETAILED DESCRIPTION

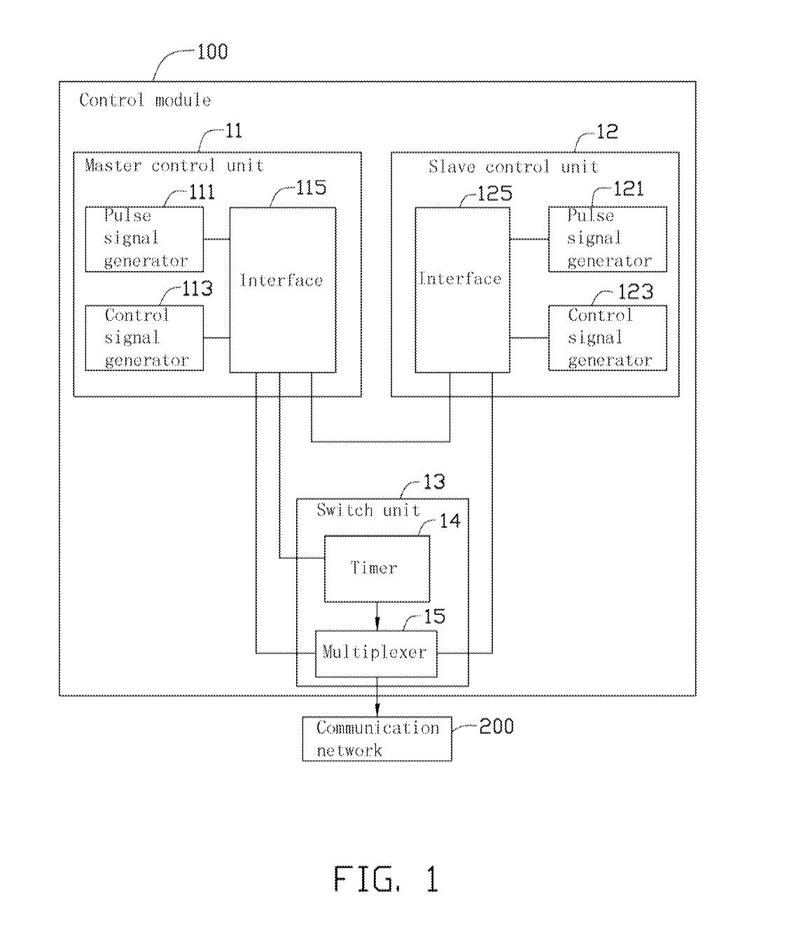

FIG. 1 shows a control module 100, according to a first exemplary embodiment. The control module 100 can be used in a server (not shown) of a communication network 200 such as the Internet or an intranet, to control the communication network 200. The control module 100 includes a master control unit 11, a slave control unit 12, and a switch unit 13.

The master control unit 11 includes a pulse signal generator 111, a control signal generator 113, and an interface 115. The pulse signal generator 111 and the control signal generator 113 are both electrically connected to the interface 115. The pulse signal generator 111 can generate a master pulse signal, and the control signal generator 113 can generate a master control signal. Similar to the master control unit 11, the slave control unit 12 includes a pulse signal generator 121, a control signal generator 123, and an interface 125. The pulse signal generator 121 and the control signal generator 123 are both electrically connected to the interface 125. The pulse signal generator 131 can generate a slave pulse signal, and the control signal generator 123 can generate a slave control signal.

The interface 115 and the interface 125 are electrically connected to each other. In use, the master pulse signal is transmitted to the slave control unit 12 through the interfaces 115, 125, and the slave pulse signal is transmitted to the master control unit 11 through the interfaces 125, 115. Upon receiving each other's pulse signals, the master control unit 11 and the slave control unit 12 can cooperatively regulate phases of the master pulse signal and the slave pulse signal to be synchronous. However, in the first exemplary embodiment, only the master pulse signal is used.

The switch unit 13 includes a timer 14 and a multiplexer 15. The timer 14 is electrically connected to the interface 115 and the multiplexer 15. The master pulse signal is transmitted to the timer 14 via the interface 115 to periodically reset the timer 14. Therefore, the master pulse signal prevents the timer 14 from timing for an interval that exceeds a period of the master pulse signal. The timer 14 can generate selecting signals having different voltage levels changing according to the timing status of the timer 14. Particularly, if timing intervals of the timer 14 are shorter than or equal to the period of the master pulse signal, the timer 14 generates a first selecting signal, for example, a signal with a relatively higher voltage level. If a timing interval of the timer 14 exceeds the period of the master pulse signal, the timer 14 generates a second selecting signal, for example, a signal with a relatively lower voltage level. The multiplexer 15 receives the selecting signals from the timer 14.

The interfaces 115, 125 are both electrically connected to the multiplexer 15. The master control unit 11 and the slave control unit 12 respectively transmit the master control signal and the slave control signal to the multiplexer 15 through the interfaces 115, 125. The multiplexer 15 is electrically connected to the communication network 200, and selectively transmits one of the master control signal and the slave control signal to the communication network 200 to place the communication network 200 under control of either the master control unit 11 or the slave unit 12 accordingly. Particularly, the multiplexer 15 transmits the master control signal to the communication network 200 when receiving the first selecting signal, and transmits the slave control signal to the communication network 200 when receiving the second selecting signal.

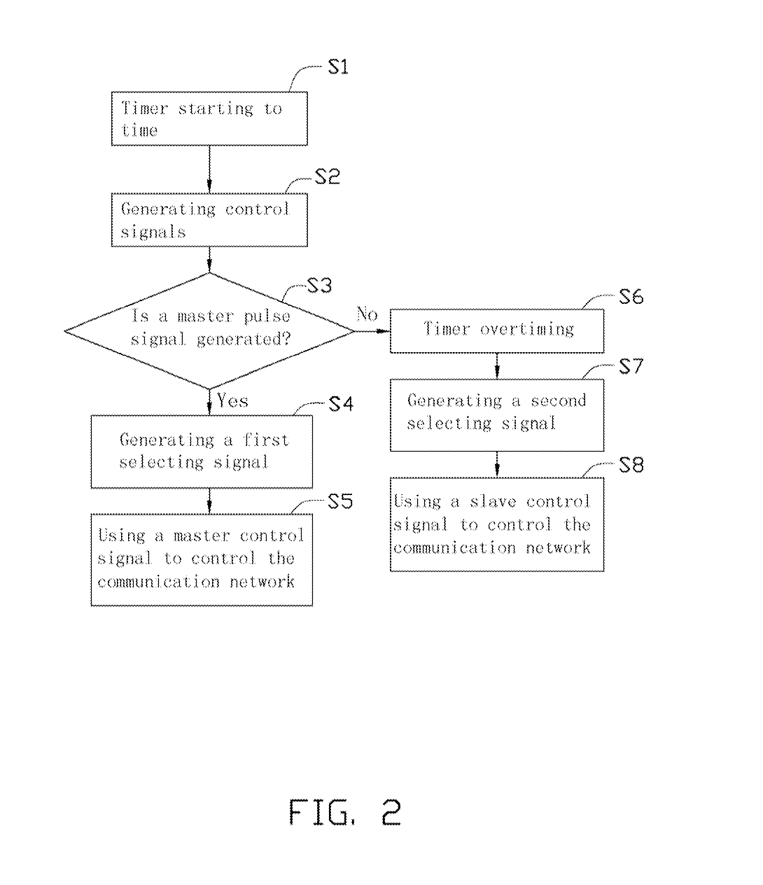

Referring to FIG. 2, a method of using the control module 100 to control the communication network 200, according to an exemplary embodiment, is provided. The method includes the following operations

The timer 14 starts to time (S1). The control signal generators 113, 123 respectively generate the master control signal and the slave control signal and transmit the master control signal and the slave control signal to the multiplexer 15 (S2). At the same time, the switch unit 13 detects if the master pulse signal is generated (S3). If the master control unit 11 works normally, the pulse signal generator 113 generates the master pulse signal and transmits the master pulse signal to the timer 14 to periodically reset the timer 14. Upon receiving the master pulse signal, the timer 14 generates the first selecting signal and transmits the first selecting signal to the multiplexer 15 (S4). Upon receiving the first selecting signal, the multiplexer 15 transmits the master control signal to the communication network 200 (S5). Thus, the communication network 200 is controlled by the master control unit 11.

If the master control unit 11 malfunctions, it is not able to generate the master pulse signal. Without receiving the master pulse signal, the timer 14 is not periodically reset and an interval from the last reset exceeds the period of the master pulse signal, i.e., overtime (S6). Thus, the timer 14 generates the second selecting signal and transmits the second selecting signal to the multiplexer 15 (S7). Upon receiving the second selecting signal, the multiplexer 15 transmits the slave control signal to the communication network 200 (S8). Thus, the communication network 200 is controlled by the slave control unit 12. In this way, master control unit 11 malfunctions will not interfere with functioning of the communication network 200. When the master control unit 11 is repaired, the master pulse signal transmitted to the timer 14 resumes. Thus, the timer 14 resumes to generate the first selecting signal transmitted to the multiplexer 15. Upon receiving the first selecting signal, the multiplexer 15 resumes transmitting the master control signal to the communication network 200, returning control of the communication network 200 to the master control unit 11 again.

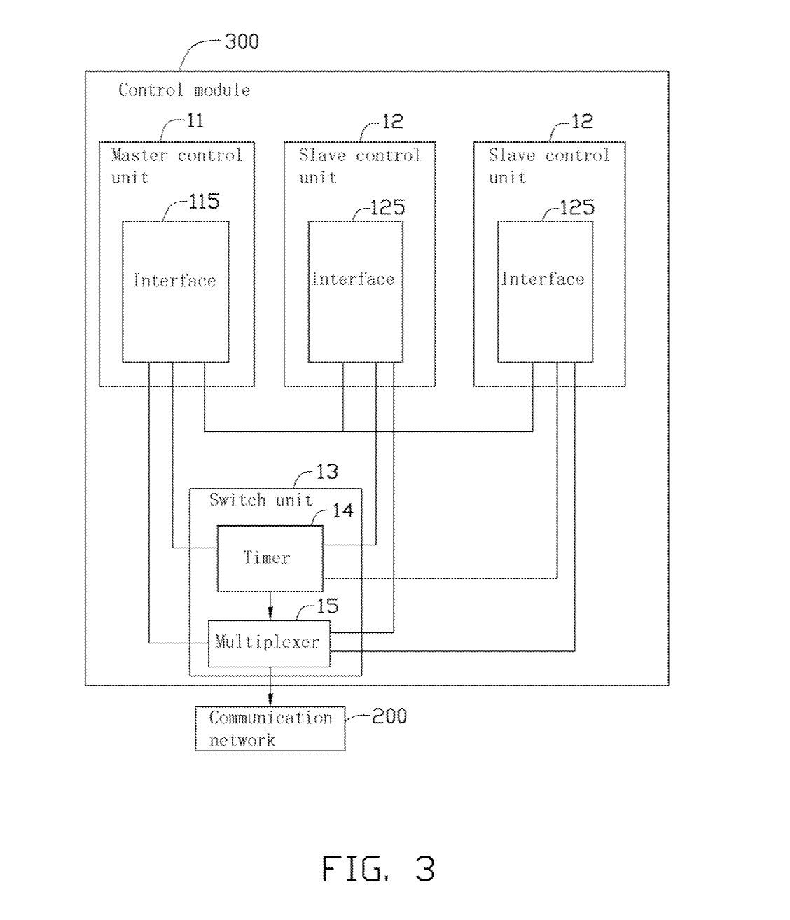

Referring to FIG. 3, a control module 300, according to a second exemplary embodiment, is provided. The control module 300 is similar to the control module 100, except that the control module 300 includes a plurality of slave control units 12. The interface 115 of the master control unit 11 and the interfaces 125 of all the slave control units 12 are electrically connected to each other, such that the master control unit 11 and all the slave control units 12 can respectively receive the master/slave pulse signals of each other. Upon receiving pulse signals generated by each other, the master control unit 11 and the slave control units 12 cooperatively regulate phases of the master pulse signal and the slave pulse signals to be synchronous.

The interface 115 and all the interfaces 125 are also electrically connected to the timer 14 and the multiplexer 15, such that all the pulse signals generated by the master control unit 11 and the slave control units 12 are transmitted to the timer 14, and all the control signals generated by the master control unit 11 and the slave control units 12 are transmitted to the multiplexer 15. When the master pulse signal stops, the switch unit 13 can select one of all the slave pulse signals to periodically reset the timer 14, and the timer 14 then generates a selecting signal corresponding to the selected slave pulse signal and transmits the selecting signal to the multiplexer 15. Upon receiving the selecting signal, the multiplexer 15 transmits the slave control signal generated by a slave control unit 12 that generates the selected slave pulse signal to the communication network 200 to control the communication network 200.

Similar to use of the control module 100, in use of the control module 300, when receiving the master pulse signal, the switch unit 13 first transmits the master control signal to the communication network 200 to control the communication network 200. When the master control unit 12 malfunctions and stops generating the master pulse signal, the switch unit 13 selects a slave control unit 12 to control the communication network 200. Particularly, the switch unit 13 transmits the slave pulse signal generated by the selected slave control unit 12 to the timer 14 to periodically reset the timer 14, and the timer 14 generates a selecting signal corresponding to the selected control unit 12 and transmits the selecting signal to the multiplexer 15. Upon receiving the selecting signal, the multiplexer 15 transmits the slave control signal generated by the selected slave control unit 12 to the communication network 200 to control the communication network 200, thereby maintaining the communication network 200 to function normally. If the selected slave control unit 12 also malfunctions, the switch unit 13 can detect that the selected control unit 12 stops generating the slave pulse signal, and then select one of other slave control units 12 to control the communication network 200 as above detailed method.

The present control module 100 can automatically switch the communication network 200 to be selectively controlled by the master control unit 11 and the at least one slave control unit 12, thereby maintaining the communication network 200 to function normally when the master control unit 11 malfunctions. Compared with conventional switch devices for switching communication networks to be selectively controlled by different control units, the control module 100 has a simpler hardware structure and conserves cost.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A control module for controlling a communication network, comprising:
a master control unit generating a master control signal and a master pulse signal;
a slave control unit generating a slave control signal; and
a switch unit electrically connected to the master control unit, the slave control unit, and the communication network; the switch unit including a timer and a multiplexer, wherein the timer receives the master pulse signal, generates a first selecting signal when the master pulse signal exists, or generates a second selecting signal when the master pulse signal stops; the multiplexer receives the master control signal, the slave control signal, and the first/second selecting signal, transmits the master control signal to the communication network when receiving the first selecting signal, or transmits the slave control signal to the communication network when receiving the second selecting signal.

2. The control module as claimed in claim 1, wherein the master pulse signal periodically resets the timer to prevent the timer from timing for an interval that exceeds a period of the master pulse signal.

3. The control module as claimed in claim 2, wherein when timing intervals of the timer are shorter than or equal to the period of the master pulse signal, the timer generates the first selecting signal; when a timing interval of the timer exceeds the period of the master pulse signal, the timer generates the second selecting signal.

4. The control module as claimed in claim 1, wherein the first selecting signal and the second selecting signals are in different voltage levels.

5. A control module for control a communication network, comprising:
a master control unit generating a master control signal and a master pulse signal;
a plurality of slave control units, each slave control unit generating a slave control signal; and
a switch unit electrically connected to the master control unit, the slave control units, and the communication network; the switch unit including a timer and a multiplexer, wherein the timer receives the master pulse signal, generates a selecting signal corresponding to the master control unit when the master pulse signal exists, and generates a selecting signal corresponding to a selected slave control unit when the master pulse signal stops; the multiplexer receives the master control signal, the slave control signals, and the selecting signals, transmits the master control signal to the communication network when receiving the selecting signal corresponding to the master control unit, and transmits the slave control signal generated by the selected slave control unit to the communication network when receiving the selecting signal corresponding to the selected slave control unit.

6. The control module as claimed in claim 5, wherein the master pulse signal periodically resets the timer to prevent the timer from timing for an interval that exceeds a period of the master pulse signal.

7. The control module as claimed in claim 6, wherein when timing intervals of the timer are shorter than or equal to the period of the master pulse signal, the timer generates the selecting signal corresponding to the master control unit.

8. The control module as claimed in claim 7, wherein each slave control unit generates a slave pulse signal transmitted to the timer; when a timing interval of the timer exceeds the period of the master pulse signal, a slave pulse signal of a selected slave control unit is used to periodically reset the timer, and the timer then generates the selecting signal corresponding to the selected slave pulse signal.

9. The control module as claimed in claim 8, wherein the phases of the master pulse signal and the slave pulse signals are synchronous.

10. A method for controlling a communication network, comprising:
providing a control module including a master control unit, a slave control unit, a timer, and a multiplexer;
using the timer to time;
using the master control unit to generate a master control signal and a master pulse signal, transmit the master control signal to the multiplexer, and transmit the master pulse signal to the timer;
using the slave control unit to generate a slave control signal and transmit the slave control signal to the multiplexer;
using the timer to generate a first selecting signal transmitted to the multiplexer when the master pulse signal exists, and generate a second selecting signal transmitted to the multiplexer when the master pulse signal stops; and
using the multiplexer to transmit the master control signal to the communication network when the multiplexer receives the first selecting signal, and transmit the slave control signal to the communication network when the multiplexer receives the second selecting signal.

11. The method as claimed in claim 10, further comprising providing a plurality of slave control units, each slave control unit generating a slave control signal and a slave pulse signal; when the master pulse signal stops, a selected slave pulse signal being used to periodically reset the timer; the timer generating a selecting signal corresponding to the selected slave pulse signal transmitted to the multiplexer; and the multiplexer transmitting the slave control signal generated by the slave control unit that generates the selected slave pulse signal to the communication network.

12. The method as claimed in claim 11, wherein the phases of the master pulse signal and the slave pulse signals are synchronous.
